(19) United States
(12) Patent Application Publication
(10) Pub. No.: US 2015/0138944 A1
(43) Pub. Date: May 21, 2015

(54) DETERMINING A PRIMARY WIRELESS ACCESS POINT (WAP) OBJECT FROM COVERAGE PREDICTIONS FOR TRIAL WAP CONFIGURATIONS

(71) Applicant: Hewlett-Packard Development Company, L.P., Houston, TX (US)

(72) Inventors: Fabiel Zuniga Gallegos, Roseville, CA (US); Allan Delgado Campos, San Jose (CR)

(21) Appl. No.: 14/396,733

(22) PCT Filed: Apr. 30, 2012
(86) PCT No.: PCT/US2012/035733

§ 371 Date: Oct. 23, 2014

(51) Int. Cl. H04W 24/04

(52) U.S. Cl. CPC H04W 24/04
USPC 370/216

(57) ABSTRACT

Examples disclosed herein relate to determining a primary wireless access point (WAP) object from coverage predictions for trial WAP configurations. Examples include determining that one of a plurality of WAP objects is a primary WAP object based on the coverage predictions and at least one coverage monitor.

### BACKGROUND

An electronic device with wireless communication capabilities, such as a desktop or notebook computer, tablet computer, or smart device, may wirelessly connect to a computer network via a wireless access point (WAP). In such examples, the electronic device may connect to the network via the WAP when it is within the transmission range of the WAP. In some examples, a plurality of WAPs may be placed around a site, such as an office or school, in order to provide wireless access to the network from many locations around the site.

### BRIEF DESCRIPTION OF THE DRAWINGS

The following detailed description references the drawings, wherein:

FIG. 1 is a block diagram of an example computing device to determine that a wireless access point (WAP) object is a primary WAP object;

FIG. 2A is a schematic diagram of an example computing device and coverage prediction for a site model including a plurality of WAP objects;

FIG. 2B is a schematic diagram of an example computing device and a coverage prediction for a compensating WAP configuration for a site model including a plurality of WAP objects;

FIG. 2C is a schematic diagram of an example computing device and a coverage prediction for a substitute WAP configuration for a site model including a plurality of WAP objects;

FIG. 3 is a block diagram of an example computing device to configure a WAP manager with a compensating WAP configuration;

FIG. 4 is a block diagram of an example computing device to generate a fault tolerance report for a plurality of WAP objects;

FIG. 5 is a flowchart of an example method for determining that a WAP object is a primary WAP object; and

FIG. 6 is a flowchart of an example method for determining compensating and substitute WAP configurations.

### DETAILED DESCRIPTION

As noted above, a plurality of wireless access points (WAPs) may be placed around a site, such as an office or school. The respective locations of the WAPs may be chosen such that the WAPs provide wireless coverage to each desired location within the site. In some scenarios, certain locations within the site may lose wireless coverage if one of the WAPs fails or otherwise malfunctions. In some examples, if a WAP is malfunctioning, the respective coverage areas of other WAPs at the site may be increased to compensate for the malfunctioning WAP. In such examples, the coverage area of a WAP may be increased by increasing the transmit power of the WAP's radios, for example.

However, in some scenarios, the placement of WAPs around a site may be such that the coverage areas of the functioning WAPs cannot be increased to completely compensate for the malfunctioning WAP. In other examples, increasing the coverage area of the functioning WAPs to compensate for the malfunctioning WAP may cause at least one of the WAPs to provide wireless coverage to a portion of the site where wireless coverage is undesirable, such as a parking lot. Additionally, an administrator for the site, for example, may not be aware that, in a given arrangement, the WAPs would not be able to acceptably compensate for a particular WAP if it were to malfunction.

To address these issues, examples described herein may determine coverage predictions for a plurality of WAP objects representing WAPs in a site model, and determine whether the coverage predictions satisfy parameters of coverage monitors indicating the desired coverage for different regions of a site model including the WAP objects. Some examples may determine, from the coverage predictions and coverage monitors, whether a WAP object is a primary WAP object representing a WAP for which other WAPs may not be able to appropriately compensate if the WAP were to malfunction. Some examples described herein may generate a report identifying the primary WAP objects of the site model. In this manner, examples described herein may determine how tolerant a proposed or actual placement of WAPs would be to WAPs malfunctioning. In some examples, a user (e.g., a site administrator) may use this information to determine whether to change the proposed or actual WAP placement.

Additionally, some examples described herein may propose WAP configurations to use when a WAP is malfunctioning. Such WAP configurations may include, for example, the transmit power settings for each of the functioning WAPs. In such examples, the WAP configurations may include compensating WAP configurations that may be used to completely compensate for a malfunctioning WAP and substitute WAP configurations that may be used to partially compensate for a malfunctioning WAP. Additionally, in some examples, a user (e.g., an administrator) may configure a WAP manager to apply a proposed compensating or substitute WAP configuration if a corresponding WAP is determined to be malfunctioning. In this manner, examples described herein may allow a user to configure a WAP manager to at least partially compensate for a malfunctioning WAP.

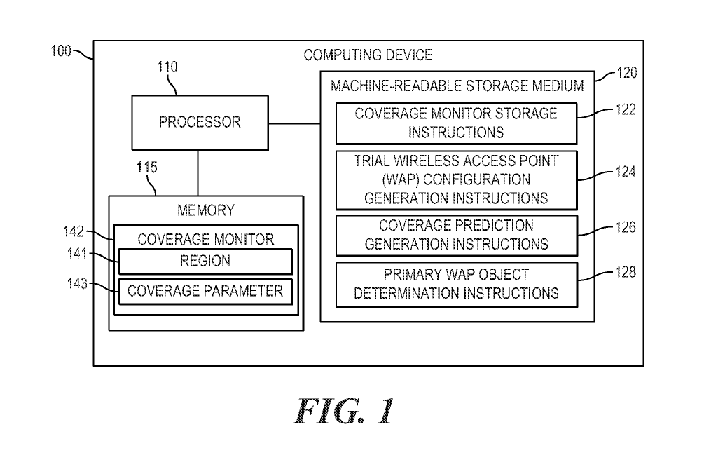

Referring now to the drawings, FIG. 1 is a block diagram of an example computing device 100 to determine that a WAP object is a primary WAP object. As used herein, a “computing device” may be a server, a desktop or notebook computer, a computer networking device, or any other device or equipment including a processor. In the example of FIG. 1, computing device 100 includes a processor 110, a memory 115, and a machine-readable storage medium 120 including (e.g., encoded with) instructions 122, 124, 126, and 128. In some examples, storage medium 120 may include additional instructions. In other examples, instructions 122, 124, 126, 128, and any other instructions described herein in relation to storage medium 120 may be stored remotely from computing device 100.

As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. Processor 110 may fetch, decode, and execute instructions stored on storage medium 120 to implement the functionalities described below. In other examples, the functionalities of any of the instructions of storage medium 120 may be implemented in the form of electronic circuitry, in the form of executable instructions encoded on a machine-readable storage medium, or a combination thereof.

As used herein, a “machine-readable storage medium” may be any electronic, magnetic, optical, or other physical storage device to contain or store information such as executable instructions, data, and the like. For example, any machine-readable storage medium described herein may be any of Random Access Memory (RAM), flash memory, a storage drive (e.g., a hard disk), a Compact Disc Read Only Memory (CD-ROM), and the like, or a combination thereof. Further, any machine-readable storage medium described herein may be non-transitory. In the example of FIG. 1, memory 115 may be a machine-readable storage medium. In some examples, memory 115 may be separate from storage medium 120. In other examples, memory 115 may be part of storage medium 120.

In some examples, instructions 122 may store, in memory 115, a site model including a plurality of WAP objects. As used herein, a “site model” is a collection of information including a plurality of site characteristics defining a representation of an actual environment or an environment design. In some examples, site characteristics may include a definition of the outer boundaries of the environment of the site model. In some examples, site characteristics may also include boundaries of at least one inner portion of the environment. Site characteristics may also include, for example, at least one of the predicted signal attenuation for at least a portion of the environment, and the location and signal attenuating properties of at least one object in the environment. In some examples, site characteristics may further define a plurality of regions within the outer boundaries of the environment, and each of the regions may have at least one associated site characteristic. In some examples, the site model may be stored in memory 115.

Additionally, as used herein, a “wireless access point (WAP) object” of a site model is a collection of information representing a wireless access point. In some examples, a WAP object may specify characteristics of the WAP object, such as its current location within the site model, predicted signal transmission and reception capabilities, and at least one WAP setting, such as a channel and a transmit power for the WAP object. In some examples, a WAP object may represent an actual or designed WAP and the characteristics defined by the WAP object may represent corresponding characteristics of the WAP. As used herein, a “wireless access point (WAP)” is an electronic device comprising at least one radio for wirelessly sending and receiving communications to and from a remote electronic device to wirelessly connect the remote electronic device to a computer network. In some examples, the WAP objects of a site model may represent a proposed or actual placement of WAPs in an environment represented by the site model.

In the example of FIG. 1, instructions 122 may also store, in memory 115, at least one coverage monitor 142 for the site model. As used herein, a “coverage monitor” is a collection of information defining the location and boundaries of a region within the site model, and specifying at least one coverage parameter for the associated region. In some examples, coverage monitor 142 defines an associated region 141 and includes at least one coverage parameter 143 for associated region 141. As used herein, the region defined by a coverage monitor may be referred to as an “associated region” of the coverage monitor.

In the example of FIG. 1, an initial WAP configuration may be determined from initial WAP setting values of the plurality of WAP objects stored for the site model. For example, the initial WAP configuration may be generated by an iterative process of instructions 124, 126, and 128 described below. As used herein, a “WAP configuration” for a plurality of WAP objects is a set of WAP setting values including at least one WAP setting value for at least one of the WAP objects. For example, a WAP configuration for a plurality of WAP objects may include a transmit power value for each of the WAP objects. As used herein, an “initial WAP configuration” for a plurality of WAP objects is a WAP configuration including at least one WAP setting value for each WAP object of the plurality.

In some examples, instructions 126 may generate a coverage prediction for the initial WAP configuration. As used herein, a “coverage prediction” for a WAP configuration for a plurality of WAP objects is a prediction of at least the coverage area that would be provided by a plurality of WAPs represented by the WAP objects, respectively, and having the WAP setting values specified by the WAP configuration for the WAP objects. In some examples, the coverage prediction for a WAP configuration for a plurality of WAP objects may include a predicted coverage area for each of the WAP objects included in the WAP configuration. The predicted coverage area for a WAP object may be a prediction of at least the coverage area that would be provided by a WAP represented by the WAP object and having the WAP setting values specified by the WAP configuration for the WAP object. In some examples, WAP setting values of the WAP objects may be used to generate the coverage prediction if values for those WAP settings are not specified in the WAP configuration. Additionally, as used herein, a “coverage area” represents an area within which a WAP may communicate wirelessly with another electronic device. In some examples, a coverage prediction for a WAP configuration may further include a prediction of the quality of service provided within the coverage area. Instructions 128 may determine whether a coverage prediction for a WAP configuration for the WAP objects satisfies each coverage parameter 143 of each coverage monitor 142.

As used herein, a “coverage parameter” for a coverage monitor is information identifying a wireless coverage characteristic to be met in the region associated with the coverage monitor. Example coverage parameters 143 include coverage type parameters, which specify a type of coverage to be provided in the associated region of the coverage monitor to satisfy the coverage parameter. Such coverage type parameters may include, for example, a full-coverage parameter, a no-coverage parameter, and a selective coverage parameter. Other example coverage parameters 143 include signal quality parameters specifying, for example, at least one of a minimum, maximum, or average signal level to be met in the associated region 141 of the coverage monitor 142.

As used herein, a “full-coverage parameter” is a coverage parameter that is satisfied by any coverage prediction having a predicted coverage area including the entire region associated with a coverage monitor including the full-coverage parameter. As used herein, a “no-coverage parameter” is a coverage parameter that is satisfied by any coverage prediction having a predicted coverage area excluding the entire region associated with a coverage monitor including the no-coverage parameter. As used herein, a “selective coverage parameter” is a coverage parameter that is satisfied by any coverage prediction. For example, the selective coverage parameter may be satisfied if a predicted coverage area includes some, all, or none of the region associated with the coverage monitor including the selective coverage parameter. In this manner, the selective coverage parameter may be associated with a region in which coverage may be provided, and in which partial or no coverage is also acceptable.

In some examples, instructions 128 may compare the coverage prediction to each coverage parameter 143 of each coverage monitor 142 for the site model to determine whether the coverage prediction satisfies each coverage parameter 143 of each coverage monitor 142. In such examples, instructions 128 may determine that a coverage prediction satisfies a full-coverage parameter of a coverage monitor if a predicted coverage area of the coverage prediction includes the entire region associated with the coverage monitor. In some examples, instructions 128 may determine that a coverage prediction satisfies a no-coverage parameter of a coverage monitor if a predicted coverage area of the coverage prediction excludes the entire region associated with the coverage monitor. Instructions 128 may determine that any coverage prediction satisfies a selective coverage parameter of a coverage monitor regardless of whether the coverage prediction includes any of the region associated with the coverage monitor.

Additionally, in some examples, instructions 128 may determine that a coverage prediction satisfies a minimum signal parameter if the coverage prediction indicates that the entire region associated with the coverage parameter is predicted to receive at least the minimum signal level (e.g. −70 dBm, −80 dBm, etc.) included in the minimum signal parameter. Instructions 128 may also determine that a coverage prediction satisfies a maximum signal parameter if the coverage prediction indicates that the entire region associated with the coverage parameter is predicted to receive at most the signal level included in the maximum signal parameter. Instructions 128 may determine that a coverage prediction satisfies an average signal parameter if the coverage prediction indicates that the average signal level predicted for the region associated with the coverage parameter is at least the signal level included in the average signal parameter.

In the example of FIG. 1, if instructions 128 determine that a coverage prediction for the initial WAP configuration satisfies each coverage parameter 143 of each of the coverage monitors 142, then instructions 124 may generate, with processor 110, a plurality of trial WAP configurations, wherein one of the WAP objects is disabled in each of the trial WAP configurations generated by instructions 124. As used herein, a WAP object may be “disabled” in a WAP configuration by excluding the WAP object from the WAP configuration, setting the transmit power of the WAP object to zero in the WAP configuration, or otherwise providing at least one WAP setting value for the WAP object in the WAP configuration to cause the WAP object to have a no coverage area in a coverage prediction for the WAP configuration. Additionally, as used herein, a trial WAP configuration “for” a given WAP object is a trial WAP configuration in which the given WAP object is disabled. In some examples, by disabling one of the WAP objects in each of the trial WAP configurations, instructions 124, 126, and 128 may simulate one of a plurality of WAPs malfunctioning.

In some examples, instructions 126 may generate, with processor 110, a coverage prediction for each of the trial WAP configurations generated by instructions 124. In such examples, instructions 128 may determine, with processor 110, that a first one of the WAP objects is a primary WAP object if none of the coverage predictions, for the trial WAP configurations in which the first WAP object is disabled, satisfies each coverage parameter 143 of each coverage monitor 142. As used herein, a “primary WAP object” is a given WAP object of a plurality of WAP objects of a site model for which the at least one other WAP object of the plurality may not be able to compensate, while satisfying each coverage parameter of each coverage monitor of the site model, if the given WAP object is disabled.

In some examples, instructions 124 may generate the trial WAP configurations iteratively. For example, for a selected WAP object, instructions 124 may iteratively generate a plurality of trial WAP configurations in which the selected WAP object is disabled in each of the trial WAP configurations. In such examples, for each iteration, instructions 126 may generate a coverage prediction for the trial WAP configuration generated in that iteration and determine whether the coverage prediction satisfies each coverage parameter of each of the coverage monitors for the site model. In some examples, the iterations with the selected WAP object disabled may continue until either instructions 128 determine that a coverage prediction for one of the trial WAP configurations satisfies each coverage parameter of each coverage monitor, or a threshold number of iterations for the selected WAP object have been completed without determining that a coverage prediction for any of the generated trial WAP configurations satisfies each coverage parameter. In such examples, instructions 128 may determine that the selected WAP object is a primary WAP object if the threshold number of iterations is reached and none of the coverage predictions for the generated trial WAP configurations satisfies each coverage parameter of each coverage monitor for the site model. In some examples, the iterative process described above in relation to instructions 124, 126, and 128 may be performed for each WAP object as the selected WAP object. In such examples, instructions 128 may evaluate trial WAP configurations to determine, for each WAP object, whether the WAP object is a primary WAP object.

In some examples, instructions 124 may generate new WAP configurations by adjusting at least one WAP setting value of preceding WAP configurations. For example, instructions 124 may generate a new WAP configuration from a preceding WAP configuration by adjusting at least one setting value (e.g., a transmit power value) for at least one WAP object included in the preceding WAP configuration. In some examples, instructions 124 may begin generating WAP configurations from a preliminary or initial WAP configuration. For example, to generate a first trial WAP configuration, instructions 124 may generate a trial WAP configuration that is the same as the initial WAP configuration except that one of the WAP objects of the site model is disabled in the first trial WAP configuration. In such examples, instructions 124 may generate a second trial WAP configuration in which at least one of the WAP settings for at least one of the non-disabled WAP objects is adjusted relative to the first trial WAP configuration. Any non-adjusted WAP setting may be the same in the first and second trial WAP configurations.

In such examples, each WAP setting value adjustment between sequential WAP configurations may be an increase or decrease of the value within the allowed range for the value (e.g., between 0 and 22 dBm for transmit power). In some examples, the amount of the adjustment between sequential WAP configurations may be determined heuristically. For example, an adjusted value may be determined by randomly or pseudo-randomly selecting an increment or decrement value in a range that would keep the adjusted value within the allowed range for the setting. In some examples, the increment value may be scaled based on how close a coverage prediction for the preceding WAP configuration is to satisfying each coverage parameter of each coverage monitor. In other examples, the iterative process of generating trial WAP configurations and evaluating coverage predictions for the trial WAP configurations may be implemented using a hill-climbing optimization technique (e.g., utilizing various processes described above), a genetic algorithm technique, or another heuristic-based iterative technique.

In the example of FIG. 1, instructions 124, 126, and 128 may use the iterative process described above to identify the initial WAP configuration having a coverage prediction that satisfies each coverage parameter 143 of each coverage monitor 142. As noted above, instructions 122 may store a site model, including a plurality of WAP objects, in memory 115. In such examples, respective WAP setting values of the WAP objects stored in memory 115 may be considered a preliminary WAP configuration. In some examples, instructions 124 may iteratively generate at least one proposed WAP configuration for the WAP objects, starting from the preliminary WAP configuration. At each iteration, instructions 126 may generate a coverage prediction for the proposed WAP configuration, and instructions 128 may determine that the proposed WAP configurations is the initial WAP configuration if the coverage prediction for the proposed WAP configuration satisfies each coverage parameter 143 of each coverage monitor 142 for the site model.

Examples described herein may determine that a WAP object of a plurality of WAP objects is a primary WAP object if none of the coverage predictions for the trial WAP configurations in which the WAP object is disabled satisfies each coverage parameter of each coverage monitor. In this manner, examples described herein may inform an administrator or other user that a set of WAPs represented by the WAP objects of a site model may not be able to compensate for the WAP represented by the primary WAP object if the WAP malfunctions. In some examples, this information may be used to determine whether to use or change a proposed or actual WAP placement represented by the WAP objects of the site model.

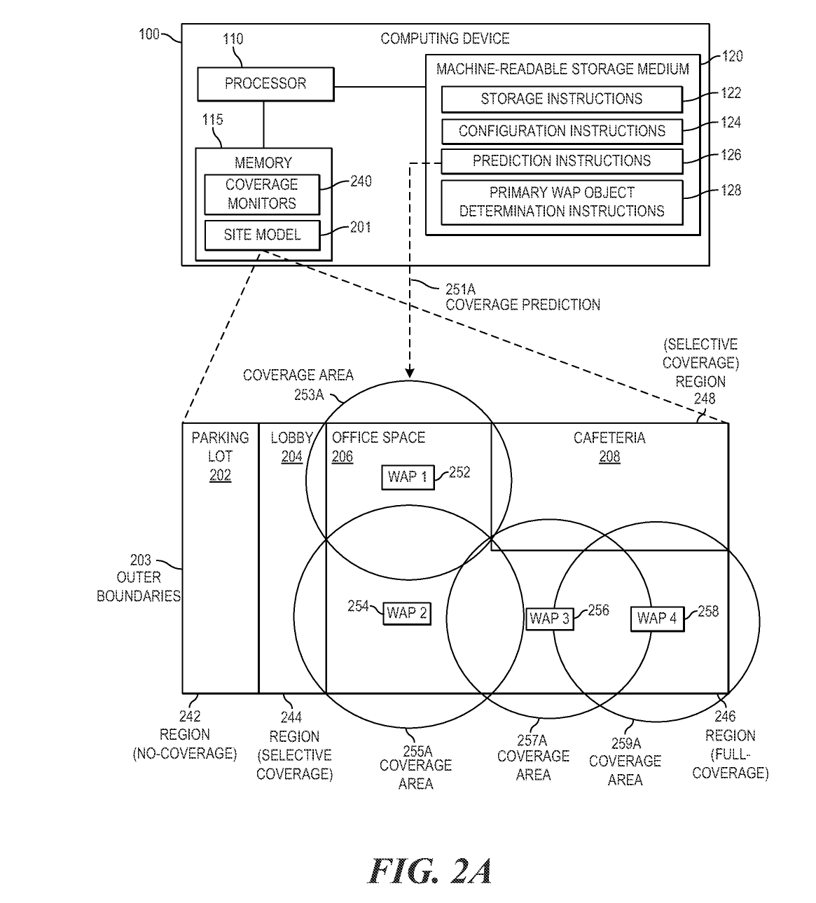

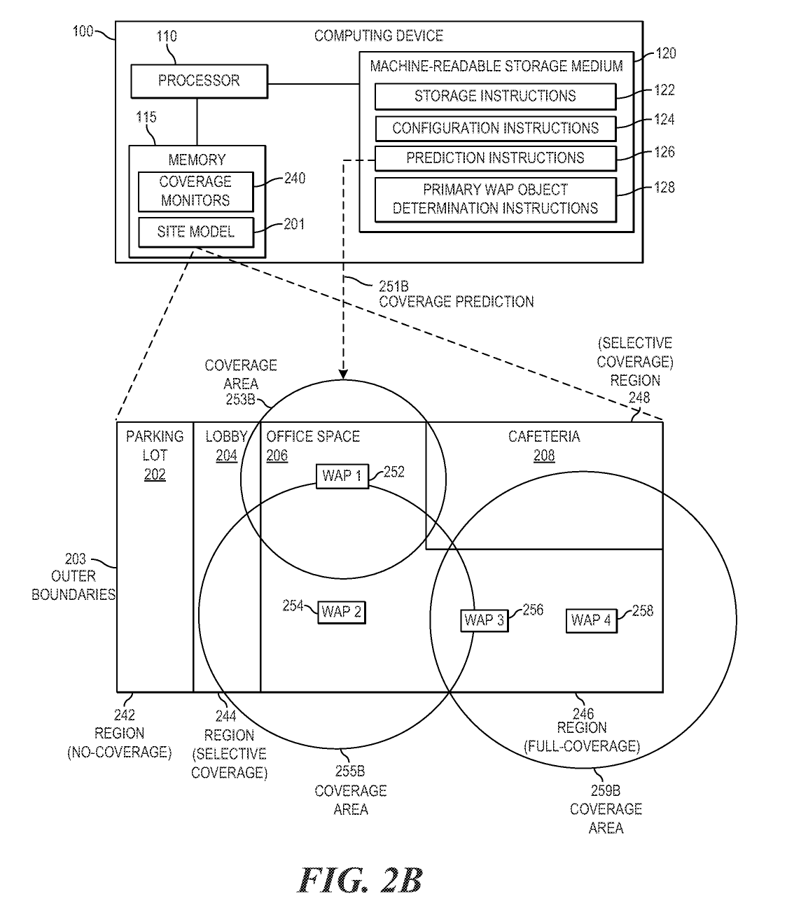

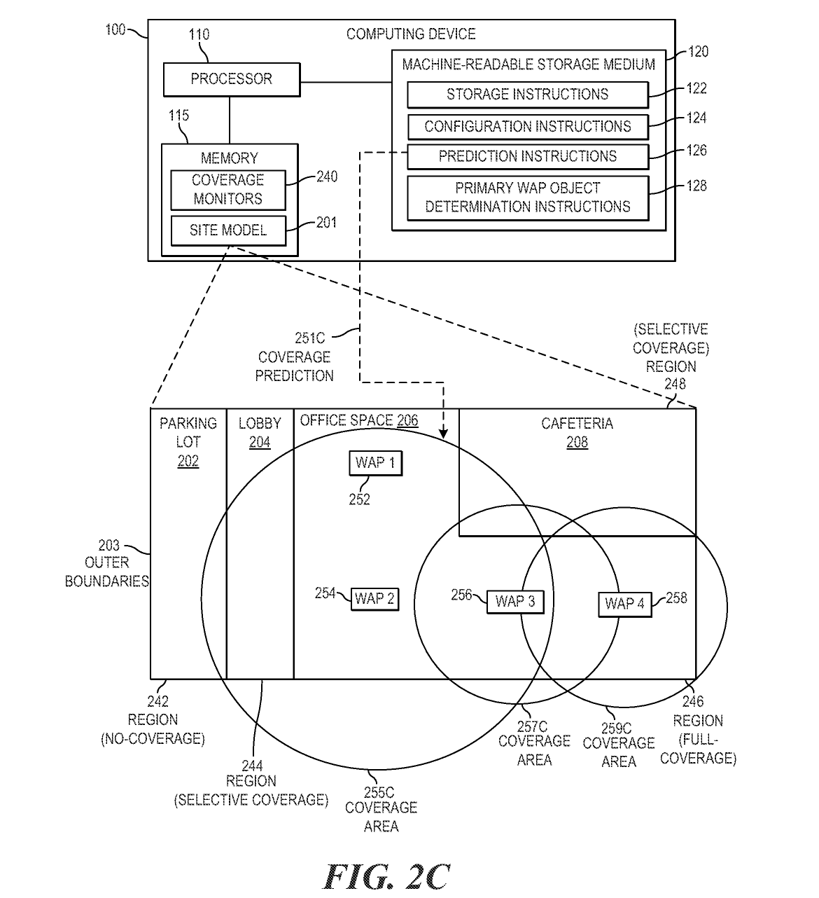

FIG. 2A is a schematic diagram of an example computing device 100 and a coverage prediction for a site model including a plurality of WAP objects. In the example of FIG. 2A, computing device 100 may be the same as computing device 100 described above in relation to FIG. 1. In some examples, instructions 122 may store a site model 201 and a plurality of coverage monitors 240 in memory 115. FIG. 2A includes a schematic diagram of site model 201. In the example of FIG. 2A, site model 201 includes a definition of the outer boundaries 203 of the environment, and definitions of the boundaries of a plurality of inner portions, including the boundaries of a parking lot 202, a lobby 204, office space 206, and a cafeteria 208 of an environment represented by site model 201. In other examples, the site model may include different inner portions, or may not be subdivided into a plurality of inner portions. In some examples, site model 201 may also identify signal attenuation properties for each of the defined inner portions of site model 201. Site model 201 may also include a plurality of WAP objects, including WAP objects 252, 254, 256, and 258.

In the example of FIG. 2A, each of coverage monitors 240 defines the location and boundaries of a region associated with the coverage monitor. In the example of FIG. 2A, a first coverage monitor of coverage monitors 240 may define an associated region 242 (which may be referred to herein as a coverage monitor region) that is coextensive with parking lot 202. In some examples, the first coverage monitor may include a no-coverage parameter for region 242. A second coverage monitor of coverage monitors 240 may define an associated region 244 that is coextensive with lobby 204. In some examples, the second coverage monitor may include a selective coverage parameter for region 244. A third coverage monitor of coverage monitors 240 may define an associated region 246 that is coextensive with office space 206. In some examples, the third coverage monitor may include a full-coverage parameter for region 246. A fourth coverage monitor of coverage monitors 240 may define an associated region 248 that is coextensive with cafeteria 208. In some examples, the fourth coverage monitor may include a selective coverage parameter for region 248.

In the example of FIG. 2A, instructions 124 may generate a preliminary WAP configuration for the WAP objects based on initial WAP settings of the WAP objects, as described above in relation to FIG. 1. In such examples, instructions 126 may generate a coverage prediction 251A for the preliminary WAP configuration. The generated coverage prediction 251A may include, for example, a predicted coverage area for each of the WAP objects based in part on the preliminary WAP configuration. For example, the predicted coverage area for coverage prediction 251A may include a predicted coverage area 253A for WAP object 252, a predicted coverage area 255A for WAP object 254, a predicted coverage area 257A for WAP object 256, and a predicted coverage area 259A for WAP object 258.

In some examples, instructions 128 may determine whether the generated coverage prediction 251A satisfies each coverage parameter of each of the coverage monitors 240. In the example illustrated in FIG. 2A, the predicted coverage area of coverage prediction 251A excludes the entire region 242 and includes the entire region 246. As such, instructions 128 may determine that coverage prediction 251A satisfies both the no-coverage parameter of the coverage monitor associated with region 242 and the full-coverage parameter of the coverage monitor associated with region 246. In addition, any coverage prediction satisfies the selective coverage parameters of the coverage monitors associated with regions 244 and 248, respectively, so instructions 128 may determine that these parameters are also satisfied by coverage prediction 251A of FIG. 2A, which includes portions of regions 244 and 248 in its predicted coverage area. Accordingly, instructions 128 may determine that coverage prediction 251A for the preliminary WAP configuration satisfies each coverage parameter of each of coverage monitors 240. In response to this determination, instructions 128 may select the preliminary WAP configuration as an initial WAP configuration for the WAP objects.

FIG. 2B is a schematic diagram of an example computing device and a coverage prediction for a compensating WAP configuration for a site model including a plurality of WAP objects. In the example of FIG. 2B, computing device 100 may be the same as computing device 100 described above in relation to FIGS. 1 and 2A. Instructions 122 may store, in memory 115, coverage monitors 240 and site model 201, as described above in relation to FIG. 2A. FIG. 2B includes a schematic diagram of site model 201.

In the example of FIG. 2B, instructions 124 may generate a plurality of trial WAP configurations for the WAP objects of site model 201, as described above in relation to FIG. 1. In some examples, WAP object 256 may be is disabled in each of the trial WAP configurations. The plurality of trial WAP configurations may be generated iteratively as described above, for example. At each iteration, instructions 126 may generate a coverage prediction for the generated trial WAP configuration and instructions 128 may determine whether the coverage prediction satisfies each coverage parameter of each of coverage monitors 240.

In the example of FIG. 2B, at one of the iterations, instructions 124 may generate a trial WAP configuration in which WAP object 256 is disabled and each of WAP objects 254 and 258 each have a greater transmit power value than in the initial WAP configuration described above in relation to FIG. 2A. At this iteration, instructions 126 may generate a coverage prediction 251B, illustrated in FIG. 2B, based in part on the trial WAP configuration. A predicted coverage area of coverage prediction 251B may include, for example, a predicted coverage area 253B for WAP object 252, a predicted coverage area 255B for WAP object 254, and a predicted coverage area 259B for WAP object 258, as illustrated in FIG. 2B.

In some examples, at this iteration, instructions 128 may determine whether the generated coverage prediction 251B satisfies each coverage parameter of each of coverage monitors 240. In the example illustrated in FIG. 2B, the predicted coverage area of coverage prediction 251B excludes the entire region 242 and includes the entire region 246. As such, coverage prediction 251B satisfies both the no-coverage parameter of the coverage monitor associated with region 242 and the full-coverage parameter of the coverage monitor associated with region 246. In addition, the selective coverage parameters of the coverage monitors associated with regions 244 and 248, respectively, are satisfied by coverage prediction 251B of FIG. 2A, which includes portions of regions 244 and 248 in its predicted coverage area. Accordingly, instructions 128 may determine that coverage prediction 251B for the trial WAP configuration satisfies each coverage parameter of each of coverage monitors 240. In such examples, instructions 128 may also determine that the trial WAP configuration is a compensating WAP configuration.

As used herein, a “compensating WAP configuration” for a plurality of WAP objects of a site model is a WAP configuration having a coverage prediction that satisfies each coverage parameter of each coverage monitor for the site model with one of the WAP objects is disabled. For example, if a site model includes a plurality of WAP objects, a WAP configuration excluding one of the WAP objects and having a coverage prediction that satisfies each of the coverage parameters of each of the coverage monitors may be considered a compensating WAP configuration. In such examples, the compensating WAP configuration may be considered to compensate for the excluded WAP object, which may be excluded to simulate the malfunctioning of a corresponding WAP. In other examples, a WAP configuration in which the transmit power of one of the WAP objects is set to zero and which has a coverage prediction that satisfies each of the coverage parameters of each of the coverage monitors may also be considered a compensating WAP configuration. In such examples, setting the transmit power to zero may simulate the malfunctioning of a corresponding WAP.

FIG. 2C is a schematic diagram of an example computing device and a coverage prediction for a substitute WAP configuration for a site model including a plurality of WAP objects. In the example of FIG. 2C, computing device 100 may be the same as computing device 100 described above in relation to FIGS. 1 and 2A. Instructions 122 may store, in memory 115, coverage monitors 240 and site model 201, as described above in relation to FIG. 2A. FIG. 2C includes a schematic diagram of site model 201.

In the example of FIG. 2C, instructions 124 may generate a plurality of trial WAP configurations for the WAP objects of site model 201, as described above in relation to FIG. 1. In some examples, WAP object 252 may be disabled in each of the trial WAP configurations. The plurality of trial WAP configurations may be generated iteratively as described above. In such examples, at each iteration, instructions 126 may generate a coverage prediction for the generated trial WAP configuration and instructions 128 may determine whether the coverage prediction satisfies each coverage parameter of each of coverage monitors 240.

In the example of FIG. 2C, at one of the iterations, instructions 124 may generate a trial WAP configuration in which WAP object 252 is disabled and each of WAP objects 254 and 258 has a transmit power value that is greater than in the initial WAP configuration described above in relation to FIG. 2A. At this iteration, instructions 126 may generate a coverage prediction 251C based in part on the trial WAP configuration. A predicted coverage area of coverage prediction 251C may include, for example, a predicted coverage area 255C for WAP object 254, a predicted coverage area 257C for WAP object 256, and a predicted coverage area 259C for WAP object 258, as illustrated in FIG. 2C.

In some examples, at this iteration, instructions 128 may also determine whether the generated coverage prediction 251C satisfies each coverage parameter of each of coverage monitors 240. In the example illustrated in FIG. 2C, the predicted coverage area of coverage prediction 251C includes a portion of region 242 and does not include the entire region 246. In such examples, instructions 128 may determine that coverage prediction 251C does not satisfy either the no-coverage parameter of the coverage monitor associated with region 242 or the full-coverage parameter of the coverage monitor associated with region 246. In some examples, after determining that a present trial WAP configuration does not satisfy each coverage parameter of each of coverage monitors 240, the iterations may continue until a threshold number of iterations have been performed with WAP object 252 disabled.

In some examples, if the threshold number of iterations with WAP object 252 disabled has been reached without determining that one of the trial WAP configurations is a compensating WAP configuration (i.e., satisfies each coverage parameter of each coverage monitor 240), then instructions 128 may select one of the trial WAP configurations as a substitute WAP configuration. As used herein, a “substitute WAP configuration” for a plurality of WAP objects of a site model is a WAP configuration in which one of the WAP objects is disabled and wherein a coverage prediction for the WAP configuration fails to satisfy at least one coverage parameter of at least one coverage monitor for the site model. For example, instructions 128 may select the trial WAP configuration having coverage prediction 251C as a substitute WAP configuration associated with WAP object 252 being disabled. In some examples, instructions 126 may select the substitute WAP configuration from among the trial WAP configurations based on at least one of a plurality of different criteria. For example, instructions 126 may select the trial WAP configuration that most nearly satisfies all of the coverage parameters.

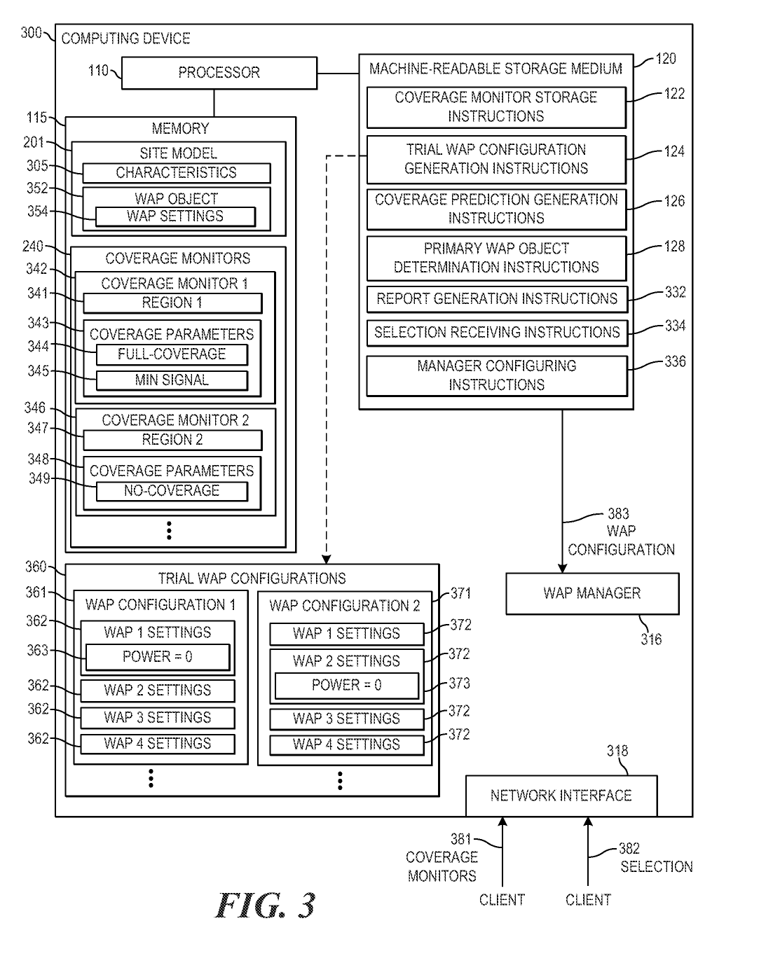

FIG. 3 is a block diagram of an example computing device 300 to configure a WAP manager with a compensating WAP configuration. In the example of FIG. 3, computing device 300 may comprise a processor 110, a memory 115, and storage medium 120, as described above in relation to FIG. 1. Storage medium 120 may include instructions 332, 334, and 336, in addition to instructions 122, 124, 126, and 128 described above in relation to FIGS. 1-2C. Computing device 300 may further include a WAP manager 316 and a network interface 318. In some examples, the functionalities of WAP manager 316 may be implemented in the form of executable instructions encoded on a machine-readable storage medium, in the form of electronic circuitry, or a combination thereof.

In the example of FIG. 3, instructions 122 may receive coverage monitors 240 via network interface 318 in at least one communication 381 and store coverage monitors 240 in memory 115. Coverage monitors 240 may be received from a client computing device remote from computing device 300 via network interface 318. In some examples, a user (e.g., an administrator) may input coverage monitors 240 at the client computing device, which may provide coverage monitors 240 to computing device 300. As used herein, a “network interface” is at least one hardware component that may be used by a computing device to communicate with at least one remote resource of a communications network including at least one computer network, at least one telephone network, or a combination thereof. In some examples, suitable computer networks include, for example, a local area network (LAN), a wireless local area network (WLAN), a virtual private network (VPN), the internet, and the like. In some examples, computing device 100 may also receive site model 201 from a remote client computing device via network interface 318.

Instructions 122 may also store site model 201 in memory 115. In the example of FIG. 3, site model 201 may include a plurality of site characteristics 305. Site characteristics 305 may include, for example, at least one of outer boundaries for an environment represented by site model 201, boundaries for inner portions of the environment, and signal attenuation properties for at least one of the inner portions of the environment. Site model 201 may also include at least one WAP object 352, each including at least one WAP setting 354, such as a transmit power for the WAP object.

In some examples, coverage monitors 240 may comprise a plurality of coverage monitors for site model 201, including at least a coverage monitor 342 and a coverage monitor 346. Alternatively, coverage monitors 240 may include one coverage monitor, such as coverage monitor 342. In other examples, coverage monitors 240 may include more than two coverage monitors. In the example of FIG. 3, each of coverage monitors 240 includes region information defining a region of site model 201 associated with the coverage monitor and at least one coverage parameter for the associated region. In some examples, each of coverage monitors 240 may include one of the plurality of coverage type parameters.

In the example of FIG. 3, coverage monitor 342 may include region information 341 defining the region of site model 201 associated with coverage monitor 342, and at least one coverage parameter 343 for the associated region defined by region information 341. Coverage parameter 343 may include at least a coverage type parameter. In the example of FIG. 3, coverage parameters 343 include a full-coverage parameter 344 and a minimum signal parameter 345. In such examples, minimum signal parameter may include a minimum signal level for the associated region of coverage monitor 342. In other examples, coverage parameters 343 may include other signal quality parameters, such as a maximum or average signal parameter, in addition to or instead of the minimum signal parameter. In some examples, at least one of coverage monitors 240 may include site information with the region information of the coverage monitor. Such site information may include, for example, the predicted signal attenuation for the region defined by the region information. For example, signals may be attenuated more quickly in some areas (e.g., dense offices) than in other areas (e.g., relatively open spaces). In some examples, such signal attenuation information may be represented by, for example, including a path loss exponent (e.g., 2.0, 3.0, 4.0, etc.) with region information for the associated coverage monitor. For example, region information 341 may include a path loss exponent (e.g., 2.0, 3.0, 4.0, etc.) associated with the region defined by region information 341.

Coverage monitor 346 may include region information 347 defining the region of site model 201 associated with coverage monitor 346, and at least one coverage parameter 348 for the associated region defined by region information 347. Coverage parameter 348 may include at least a coverage type parameter. In some examples, region information 347 may also include site characteristics, such as signal attenuation information for the region defined by region information 347. In the example of FIG. 3, coverage parameters 348 include a no-coverage parameter 349. In other examples, coverage parameters 348 may include at least one signal quality parameters, such as a minimum, maximum, or average signal parameter.

Instructions 124 may generate a plurality of trial WAP configurations 360 for WAP objects 352 of site model 201, wherein one of WAP objects 352 is disabled in each of the trial WAP configurations, as described above in relation to FIGS. 1-2C. In the example of FIG. 3, the trial WAP configurations 360 generated by instructions 124 may include at least one trial WAP configuration 361 in which a first WAP object 352 is disabled, and at least one trial WAP configuration 371 in which a second WAP object 352 is disabled. For example, trial WAP configurations 360 may include a plurality of trial WAP configurations 361 and a plurality of trial WAP configurations 371. In some examples, the trial WAP configurations 360 may include, for each WAP object, at least one trial WAP configuration in which the WAP object is disabled.

In the example of FIG. 3, each of trial WAP configurations 360 includes at least one WAP setting value for each WAP object 352. For example, each WAP configuration 360 may specify at least a transmit power value for each of the WAP objects 352. In examples described herein, the transmit power value of a WAP object of a site model may represent a transmit power value for each of the radios of a WAP represented by the WAP object.

In the example of FIG. 3, each trial WAP configuration 361 may include at least one WAP setting 362, such as a transmit power value 363, for each WAP object 352. Additionally, each trial WAP configuration 371 may include at least one WAP setting 372, such as a transmit power value 373, for each WAP object 352. As noted above, in the example of FIG. 3, one of WAP objects 352 is disabled in each of the trial WAP configurations 360. In some examples, instructions 124 may disable a WAP object in each trial WAP configuration by setting to zero the transmit power value for the WAP object being disabled. For example, as noted above, a first WAP object 352 is to be disabled in each trial WAP configuration 361. In such examples, instructions 124 may set a transmit power value 363 to zero for the first WAP object 352 in each trial WAP configuration 361. Additionally, as noted above, a second WAP object 352 is to be disabled in each trial WAP configuration 371. In such examples, instructions 124 may set a transmit power value 373 to zero for the second WAP object 352 in each trial WAP configuration 371.

In other examples, a particular WAP object may be disabled in a WAP configuration by excluding the WAP object from the WAP configuration. In some examples, instructions 124 may generate, for each WAP object 352, at least one trial WAP configuration in which the WAP object 352 is disabled. Although FIG. 3 illustrates WAP settings for four WAP objects 352 in each WAP configuration 360, in other examples, site model 201 may include more or fewer WAP objects 352, and accordingly include in each trial WAP configuration WAP setting values for more or fewer WAP objects 352.

In the example of FIG. 3, instructions 126 may generate a coverage prediction for each of trial WAP configurations 360, as described above in relation to FIGS. 1-2C. In some examples, instructions 128 may determine, for each generated coverage prediction, whether the coverage prediction satisfies each coverage parameter of each of coverage monitors 240. As described above in relation to FIG. 1, instructions 128 may determine that a first WAP object 352 is a primary WAP object if none of the coverage predictions for the trial WAP configurations 361, in which the first WAP object 352 is disabled, satisfies each coverage parameter of each of coverage monitors 240. In the example of FIG. 3, instructions 128 may similarly determine that the second WAP object 352 is a primary WAP object if none of the coverage predictions for the trial WAP configurations 371, in which the second WAP object 352 is disabled, satisfies each coverage parameter of each of coverage monitors 240. Instructions 128 may make similar determinations for each WAP object 352.

In some examples, instructions 126 may generate each coverage prediction based in part on at least one of site characteristics 305 specified by site model 201 and site characteristics specified by at least one of coverage monitors 240. For example, in making coverage predictions, instructions 126 may take into account at least one predicted signal attenuation specified in site characteristics 305, such as at least one of the predicted signal attenuation for a particular region of the site model and the predicted signal attenuation effects of objects in site model 201. Instructions 126 may also take into account at least one of site characteristics (e.g., predicted signal attenuation) specified by coverage monitors 240, and co-channel interference.

In some examples, instructions 128 may determine that one of trial WAP configurations 361 is a compensating WAP configuration if the coverage prediction for the trial WAP configuration 361 satisfies each coverage parameter of each of coverage monitors 240. In such examples, the trial WAP configuration 361 may be determined to be a compensating WAP configuration when the first WAP object 352 is disabled. Additionally, in some examples, instructions 128 may determine that one of trial WAP configurations 371 is a compensating WAP configuration if the coverage prediction for the trial WAP configuration 371 satisfies each coverage parameter of each of coverage monitors 240. In such examples, the trial WAP configuration 371 may be determined to be a compensating WAP configuration when the second WAP object 352 is disabled.

In some examples, instructions 124, 126, and 128 may implement the above-described functionalities in accordance with the iterative process described above in relation to FIGS. 1-2C. In such examples, instructions 124, 126, and 128 may generate a trial WAP configuration in which one of the WAP objects is disabled, generate a coverage prediction for the trial WAP configuration, and determine whether the coverage prediction satisfies each coverage parameter of each coverage monitor. This process may be repeated iteratively, as described above in relation to FIGS. 1-2C, until instructions 128 determine that one of the trial WAP configurations is a compensating WAP configuration or until a threshold number of iterations is reached. Additionally, this iterative process may be repeated for each WAP object, such that each WAP object is the disabled WAP object in a respective one of the repetitions.

In the example of FIG. 3, storage medium 120 may further include instructions 332, 334, and 336. Instructions 332 may generate a fault tolerance report identifying each of the WAP objects determined to be a primary WAP object by instructions 128 and each trial WAP configuration determined to be a compensating WAP configuration by instructions 128. In such examples, instructions 332 may provide the fault tolerance report to a remote client computing device via network interface 318. The fault tolerance report may, for example, be presented (e.g., displayed) to a user of the client computing device.

Instructions 334 may receive a selection 382 of at least one of the compensating WAP configurations identified in the fault tolerance report. In some examples, instructions 334 may receive a plurality of selections 382, each identifying at least one of the identified compensating WAP configurations. In the example of FIG. 3, instructions 336 may configure WAP manager 316 to apply each selected compensating WAP configuration, in response to receiving a selection 382 with instructions 334. Instructions 336 may configure WAP manager 316 at least in part by providing to WAP manager 316 a communication 383 including the compensating WAP configuration. In such examples, WAP manager 316 may manage the operation of a plurality of actual WAPs represented by WAP objects 352, respectively. For example, WAP manager 316 may determine when at least one of the WAPs is malfunctioning (e.g., when a WAP has failed) and may adjust the WAP settings of the WAPs.

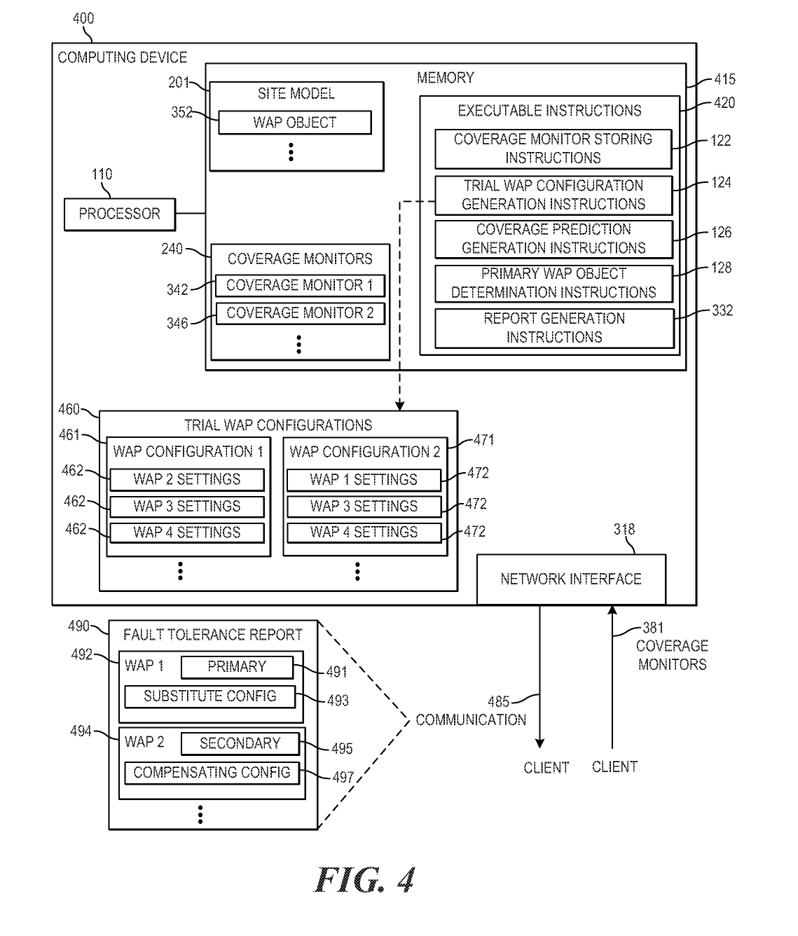

In such examples, configuring WAP manager 316 to apply a selected compensating WAP configuration may include associating the compensating WAP configuration with the WAP represented by the WAP object 352 disabled in the compensating WAP configuration. In such examples, instructions 336 may configure WAP manager 316 such that, in response to determining that the WAP associated with the compensating WAP configuration is malfunctioning, WAP manager 316 may apply the compensating WAP configuration to the WAPs. WAP manager 316 may apply the compensating WAP configuration by setting the WAP settings of the WAPs to the values specified in the compensating WAP configuration for the WAP objects representing the WAPs, respectively. In some examples, functionalities described herein in relation to FIGS. 1-3 may be provided in combination with functionalities described herein in relation to any of FIGS. 4-6.

FIG. 4 is a block diagram of an example computing device 400 to generate a fault tolerance report for a plurality of WAP objects. In the example of FIG. 4, computing device 400 may include a processor 110, as described above in relation to FIG. 1, and a network interface 318, as described above in relation to FIG. 3. Computing device 400 may also include a memory 415, which may be a machine-readable storage medium. Memory 415 may include (e.g., may be encoded with) a set of executable instructions 420, including at least instructions 122, 124, 126, 128, and 332, as described above in relation to FIGS. 1-3. In other examples, executable instructions 420 may include additional instructions. In the example of FIG. 4, processor 110 may fetch, decode, and execute instructions stored on memory 415 to implement the functionalities described below. In other examples, the functionalities of any of the instructions stored on memory 415 may be implemented in the form of electronic circuitry, in the form of executable instructions encoded on a machine-readable storage medium, or a combination thereof.

In some examples, instructions 122 may receive a site model 201 including a plurality of WAP objects 352 via network interface 318 and store the site model 201 on memory 415. Additionally, in some examples, instructions 122 may receive a plurality of coverage monitors 240 for site model 201 in a communication 381 via network interface 318. Instructions 122 may store the received coverage monitors 240 on memory 415. Coverage monitors 240 may be the same as coverage monitors 240 described above in relation to FIG. 3. For example, the plurality of coverage monitors 240 may include at least coverage monitors 342 and 346. In some examples, each of coverage monitors 240 may specify at least one coverage parameter (e.g., a coverage type parameter) for an associated region of site model 201.

In the example of FIG. 4, instructions 124, 126, and 128 may determine, for WAP objects 352, an initial WAP configuration having a coverage prediction that satisfies each coverage parameter of each of coverage monitors 240, as described above in relation to FIG. 1. In some examples, instructions 124, 126, and 128 may use the iterative process described above in relation to FIG. 1 to identify the initial WAP configuration. For example, respective WAP setting values of WAP objects 352 stored in memory 415 may be considered a preliminary WAP configuration. In such examples, instructions 124 may iteratively generate at least one proposed WAP configuration for WAP objects 352, starting from the preliminary WAP configuration. For each of the proposed WAP configurations, instructions 126 may generate a coverage prediction and instructions 128 may compare the generated coverage prediction to each coverage parameter of each of coverage monitors 240. In such examples, instructions 128 may determine that one of the proposed WAP configurations is the initial WAP configuration if the proposed WAP configuration has a coverage prediction that satisfies each coverage parameter of each of coverage monitors 240 for site model 201.

In some examples, instructions 124 may further generate a plurality of trial WAP configurations 460 for WAP objects 352, wherein each of trial WAP configurations 460 excludes one of WAP objects 352. In the example of FIG. 4, trial WAP configurations 460 generated by instructions 124 may include at least one first trial WAP configuration 461 and at least one second trial WAP configuration 471. In such examples, a first WAP object 352 is excluded from each of first trial WAP configurations 461, and a second WAP object 352 is excluded from each of second trial WAP configurations 471. In some examples, trial WAP configurations 460 may include additional trial WAP configurations.

In the example of FIG. 4, each of trial WAP configurations 460 includes at least one WAP setting value for each included WAP object 352. For example, each WAP configuration 460 may specify at least a transmit power value for each included WAP object 352. In the example of FIG. 4, each trial WAP configuration 461 may include at least one WAP setting 462 for each included WAP object 352, and each trial WAP configuration 471 may include at least one WAP setting 472 for each included WAP object 352. Although FIG. 4 illustrates WAP settings for three included WAP objects 352 in each WAP configuration 460, in other examples each trial WAP configuration 460 may include WAP setting values for more or fewer WAP objects 352 if site model 201 includes more or fewer WAP objects 352.

In some examples, instructions 124 may generate, for each WAP object 352, at least one trial WAP configuration 460 in which the WAP object 352 is excluded. In such examples, instructions 126 may generate a respective coverage prediction for each of trial WAP configurations 460 and instructions 128 may compare each of the generated coverage predictions to each coverage parameter of each of coverage monitors 240. In such examples, instructions 128 may determine, for each WAP object 352, that the WAP object 352 is a primary WAP object if the respective coverage predictions for each trial WAP configuration 460 excluding the WAP object 352 fails to satisfy at least one coverage parameter of at least one of coverage monitors 240.

In some examples, instructions 124 may, for each WAP object 352, iteratively generate trial WAP configurations 460 excluding the WAP object 352, until either a coverage prediction for one of the generated trial WAP configurations 460 excluding the WAP object 352 satisfies each coverage parameter of each of coverage monitors 240 or a threshold number of trial WAP configurations 460 excluding the WAP object 352 is generated. Instructions 124 may iteratively generate these trial WAP configurations 460 with the iterative process described above in relation to FIG. 1. In such examples, instructions 126 may generate a coverage prediction at each iteration, and instructions 128 may compare the coverage prediction to the coverage parameters at each iteration.

In some examples, to perform this iterative process, instructions 124, 126, and 128 may perform an iterative WAP configuration generating process using a plurality of variables, such as coverage monitor incompliance level (CMIL) and site coverage incompliance level (SCIL). As used herein, a “coverage monitor incompliance level (CMIL)” for a given coverage monitor and coverage prediction is the percentage of the region associated with the coverage monitor for which the coverage prediction fails to satisfy at least one coverage parameter of the coverage monitor. Additionally, as used herein, a “site coverage incompliance level (SCIL)” for a given site and coverage prediction is the average CMIL for all of the coverage monitors of the site for the given coverage prediction. In some examples, instructions 128 may determine that a coverage prediction satisfies each coverage parameter of each of coverage monitors 240 if the SCIL for the coverage prediction is zero.

In some examples, the iterative WAP configuration generating process may begin with a first WAP configuration. The first WAP configuration may be, for example, a preliminary WAP configuration for a plurality of WAP objects 352 or a trial WAP configuration generated by instructions 124 by removing one of WAP objects 352 from an initial WAP configuration, for WAP objects 352, having a coverage prediction satisfying each coverage parameter. In the iterative WAP configuration generating process, instructions 126 may determine a coverage prediction for the first WAP configuration and instructions 128 may determine an SCIL for the coverage prediction. If the SCIL is zero, then the process ends. Otherwise, instructions 124 may iteratively generate new WAP configurations from preceding WAP configurations. At each iteration, instructions 126 may generate a coverage prediction for the new WAP configuration and instructions 128 may determining the SCIL for the coverage prediction.

In such examples, a new WAP configuration is generated from a preceding WAP configuration by adjusting at least one WAP setting value of the preceding WAP configuration. New WAP configurations may be iteratively generated until instructions 128 determine that the SCIL is zero at the current iteration, or until a threshold number of iterations is reached. In some examples, the new WAP configuration is generated from a preceding WAP configuration, which is either a WAP configuration generated at a previous iteration, or the first WAP configuration if there was no previous iteration.

In some examples, the WAP setting values adjusted by instructions 124 may be the transmit power values for the WAP objects. In such examples, instructions 124 may choose an adjusted value for the transmit power for at least one of the included WAP objects 352 via a random or pseudo-random process. For example, to adjust a transmit power value of a preceding WAP configuration, instructions 124 may randomly or pseudo-randomly select an increment value in the range [−C, (M−C)], where “C” is the current transmit power value, and “M” is the maximum valid transmit power value (e.g., 22 dBm). In such examples, applying this increment value to the current value will not adjust the transmit power value outside of a valid range (e.g., 0 dBm-22 dBm).

Instructions 124 may also generate an adjusted increment value by multiplying the increment value by the current SCIL, where the SCIL is normalized to be in the range [0, 1]. In such examples, smaller increments may be applied when the SCIL is closer to zero. Instructions 124 may generate the adjusted transmit power value by adding the adjusted increment value to the current transmit power value. In other examples, other WAP setting values may be adjusted in addition to or as an alternative to transmit power values. Additionally, in other examples, the iterative process of generating trial WAP configurations and evaluating coverage predictions for the trial WAP configurations may be implemented using a hill-climbing optimization technique (e.g., utilizing various processes described above), a genetic algorithm technique, or another heuristic-based iterative technique. For example, a hill-climbing optimization technique may include an assessment procedure, a selection procedure, and a modification procedure. In such examples, utilizing a hill-climbing optimization technique may include determining an SCIL for a coverage prediction in the assessment procedure, selecting a preceding WAP configuration having a coverage prediction with the lowest SCIL among the preceding WAP configurations in the selection procedure, and generating a new WAP configuration from the selected WAP configuration (i.e., the “preceding” WAP configuration) in the modification procedure.

In some examples, trial WAP configurations 460 excluding a given WAP object 352 may be generated by performing the above-described iterative WAP configuration generating process starting from a first WAP configuration equivalent to the initial WAP configuration for WAP objects 352 with the given WAP object 352 excluded (or otherwise disabled). In such examples, the process ends when a coverage prediction for a trial WAP configuration 460 excluding the given WAP object 352 satisfies the coverage parameters (i.e., when the SCIL is zero) or when a threshold number of iterations is reached. In such examples, when a trial WAP configuration 460 having a coverage prediction that satisfies the coverage parameters is found, then instructions 128 may determine that the trial WAP configuration 460 is a compensating WAP configuration for the given WAP object 352. Alternatively, when the threshold number of iterations is reached, instructions 128 may determine the given WAP object 352 to be a primary WAP object, and may determine the generated trial WAP configuration having the lowest SCIL to be a substitute WAP configuration for the given WAP object 352.

In some examples, the above-described iterative WAP configuration generating process may be performed for each WAP object 352 as the disabled WAP object 352. In this manner, instructions 124 may iteratively generate, for each WAP object 352, trial WAP configurations 460 excluding the WAP object 352, until either a coverage prediction for one of the generated trial WAP configurations 460 excluding the WAP object 352 satisfies each coverage parameter of each of coverage monitors 240 or a threshold number of trial WAP configurations 460 excluding the WAP object 352 is generated.

In the example of FIG. 4, instructions 332 may generate a fault tolerance report 490 identifying each WAP object 352 determined to be a primary WAP object. For example, report 490 may include information for each WAP object 352. In such examples, the information for each WAP object 352 may indicate whether or not the WAP object was determined to be a primary WAP object. A WAP object determined not to be a primary WAP object may be referred to herein as a “secondary” WAP object.

In the example of FIG. 4, report 490 may include WAP object information 492 for a first WAP object 352 and WAP object information 494 for a second WAP object 352. In such examples, WAP object information 492 may include identifier 491 identifying the first WAP object 352 as a primary WAP object, and WAP object information 494 may include identifier 495 identifying the second WAP object 352 as a secondary WAP object. In some examples, report 490 may identify, for each WAP object 352, whether the WAP object was determined to be a primary or secondary WAP object.

In the example of FIG. 4, report 490 may further identify, for each WAP object determined to be a primary WAP object, a substitute WAP configuration excluding the WAP object. For example, WAP object information 492 may include a substitute WAP configuration 493. In some examples, for each substitute WAP configuration, report 490 may also identify each coverage parameter of the coverage monitors 240 that is not satisfied by a coverage prediction for the substitute WAP configuration. Additionally, in some examples, report 490 may also identify, for each WAP object 352 not determined to be a primary WAP object, a compensating WAP configuration excluding the WAP object 352. For example, WAP object information 494 may include a compensating WAP configuration 497.

In the example of FIG. 4, instructions 332 may provide fault tolerance report 490 to a remote client computing device in at least one communication 485 via network interface 318. In some examples, functionalities described herein in relation to FIG. 4 may be provided in combination with functionalities described herein in relation to any of FIGS. 1-3 and 5-6.

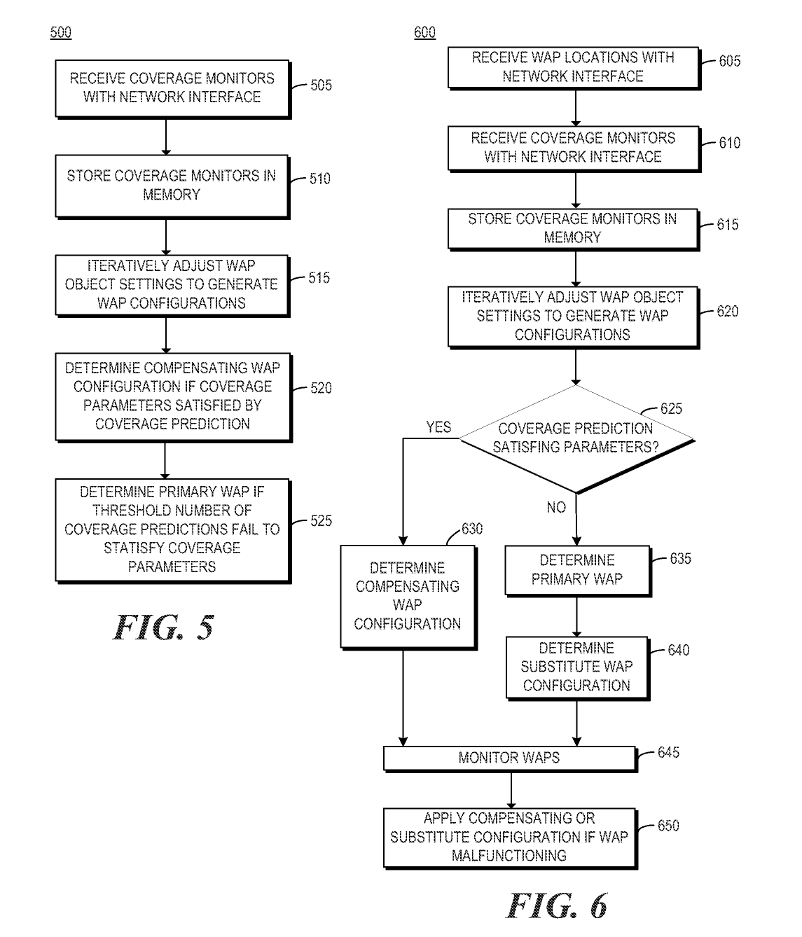

FIG. 5 is a flowchart of an example method 500 for determining that a WAP object is a primary WAP object. Although execution of method 500 is described below with reference to computing device 300 of FIG. 3, other suitable components for execution of method 500 can be utilized (e.g., computing device 100 or 400). Additionally, method 500 may be implemented in the form of executable instructions encoded on a machine-readable storage medium, in the form of electronic circuitry, or a combination thereof.

At 505 of method 500, computing device 300 may receive, with a network interface 318, a plurality of coverage monitors 240, each defining at least one coverage parameter for an associated region of a site model 201 including a plurality of WAP objects 352. At 510, processor 110 may store coverage monitors 240 in memory 115 of computing device 300.

At 515, computing device 300 may iteratively adjust WAP settings for a first set of WAP objects 352, wherein the first set excludes a first one of WAP objects 352, to generate a plurality of first trial WAP configurations (e.g., trial WAP configurations 461 of FIG. 4), if a coverage prediction for an initial WAP configuration for WAP objects 352 satisfies each coverage parameter of each of coverage monitors 240. In some examples, the first trial WAP configurations may be generated iteratively as described above in relation to at least one of FIGS. 1 and 3. Additionally, the initial WAP configuration may be generated as described above in relation to FIG. 1.

At 520, computing device 300 may determine that one of the first trial WAP configurations is a first compensating WAP configuration if a coverage prediction for the one of the first trial WAP configurations satisfies each coverage parameter of each of coverage monitors 240. In some examples, the coverage prediction may be generated as described above in relation to instructions 126, and may be compared to the coverage parameters as described above in relation to instructions 128. At 525, computing device 300 may determine that the first WAP object 352 is a primary WAP object if respective coverage predictions for a threshold number of the first trial WAP configurations each fail to satisfy at least one coverage parameter of at least one of the coverage monitors 240.

FIG. 6 is a flowchart of an example method 600 for determining compensating and substitute WAP configurations. Although execution of method 600 is described below with reference to computing device 300 of FIG. 3, other suitable components for execution of method 600 can be utilized (e.g., computing device 100 or 400). Additionally, method 600 may be implemented in the form of executable instructions encoded on a machine-readable storage medium, in the form of electronic circuitry, or a combination thereof.

At 605 of method 600, computing device 300 may receive, with a network interface 318, a respective location for each of a plurality of WAP objects 352 within a site model 201. In such examples, processor 110 may store the location for WAP objects 352 in memory 115 as part of WAP objects 352. At 610, computing device 300 may receive, with network interface 318, a plurality of coverage monitors 240, each defining at least one coverage parameter for an associated region of site model 201 including WAP objects 352. At 615, processor 110 may store coverage monitors 240 in memory 115 of computing device 300.

At 620, computing device 300 may iteratively adjust WAP settings for a first set of WAP objects 352, wherein the first set excludes a first one of WAP objects 352, to generate a plurality of first trial WAP configurations (e.g., trial WAP configurations 461 of FIG. 4), if a coverage prediction for an initial WAP configuration for WAP objects 352 satisfies each coverage parameter of each of coverage monitors 240. The initial WAP configuration may be generated as described above in relation to FIG. 1. Also at 620, computing device 300 may iteratively adjust WAP settings for a second set of WAP objects 352, excluding a second one of WAP objects 352, to generate a plurality of second trial WAP configurations (e.g., trial WAP configurations 471 of FIG. 4). In such examples, the first and second sets of WAP objects 352 may be different. In some examples, the first trial WAP configurations and the second trial WAP configurations may be generated iteratively as described above in relation to at least one of FIGS. 1 and 3.

At 625, computing device 300 may determine whether a coverage prediction for any of the first trial WAP configurations satisfies each coverage parameter for each of coverage monitors 240. If so, then method 600 may proceed to 630, where computing device 300 may determine that the first trial WAP configuration having the coverage prediction satisfying the coverage parameters is a first compensating WAP configuration. Otherwise, if it is determined that respective coverage predictions for a threshold number of the first trial WAP configurations each fail to satisfy at least one coverage parameter of at least one of the coverage monitors 240, then method 600 may proceed to 635, where method 600 may determine that the first WAP object 352 is a primary WAP object. Method 600 may then proceed to 640, where computing device 300 may determine a substitute WAP configuration excluding the first WAP object 352. For example, the first trial WAP configuration having the lowest SCIL may be determined to be the substitute WAP configuration, as described above in relation to FIG. 4.

Also at 625, computing device 300 may determine whether a coverage prediction for any of the second trial WAP configurations satisfies each coverage parameter for each of coverage monitors 240. If so, method 600 may proceed to 630 where computing device 300 may determine that one of the second trial WAP configurations is a second compensating WAP configuration. Otherwise, if it is determined that respective coverage predictions for a threshold number of the second trial WAP configurations each fail to satisfy at least one coverage parameter of at least one of the coverage monitors 240, then method 600 may proceed to 635, where method 600 may determine that the second WAP object 352 is a primary WAP object. Method 600 may then proceed to 640, where computing device 300 may determine a substitute WAP configuration excluding the second WAP object 352.

At 645, WAP manager 316 of computing device 300 may monitor each of a plurality of WAPs corresponding to WAP objects 352, respectively. At 650, WAP manager 316 may apply one of the first compensating WAP configuration and the substitute WAP configuration to the WAPs in response to determining that a first WAP, associated with the first WAP object 352, is malfunctioning. For example, if the first WAP object 352 was determined to be a primary WAP object, WAP manager 316 may apply the substitute WAP configuration if it determines that the first WAP is malfunctioning. Alternatively, if the first WAP object 352 was not determined to be a primary WAP object, WAP manager 316 may apply the first compensating WAP configuration if it determines that the first WAP is malfunctioning.

What is claimed is:

1. A non-transitory machine-readable storage medium encoded with instructions executable by a processor of a computing device, the storage medium comprising:
instructions to store, in memory of the computing device, at least one coverage monitor, each specifying at least one coverage parameter for an associated region of a site model including a plurality of wireless access point (WAP) objects;
instructions to generate, with the processor, a plurality of trial WAP configurations, wherein one of the WAP objects is disabled in each of the trial WAP configurations, if a coverage prediction for an initial WAP configuration for the WAP objects satisfies each coverage parameter of each coverage monitor;
instructions to generate, with the processor, a coverage prediction for each of the trial WAP configurations; and
instructions to determine, with the processor, that a first one of the WAP objects is a primary WAP object if none of the coverage predictions, for the trial WAP configurations in which the first WAP object is disabled, satisfies each coverage parameter of each coverage monitor.

2. The storage medium of claim 1, wherein:
the at least one coverage monitor includes a plurality of coverage monitors;
the plurality of trial WAP configurations include first trial WAP configurations in which the first WAP object is disabled and second trial WAP configurations in which a second one of the WAP objects is disabled; and
the instructions to determine that the first WAP object is a primary WAP object comprise instructions to determine that the second WAP object is a primary WAP object if none of the coverage predictions, for the second trial WAP configurations, satisfies each coverage parameter of each coverage monitor.

3. The storage medium of claim 2, wherein the instructions to determine further comprise instructions to:
determine that one of the first trial WAP configurations is a first compensating WAP configuration if the coverage prediction for the one of the first trial WAP configurations satisfies each coverage parameter of each coverage monitor; and
determine that one of the second trial WAP configurations is a second compensating WAP configuration if the coverage prediction for the one of the second trial WAP configurations satisfies each coverage parameter of each coverage monitor.

4. The storage medium of claim 3, further comprising:
instructions to generate a fault tolerance report identifying each of the WAP objects determined to be a primary WAP object and each trial WAP configuration determined to be a compensating WAP configuration;
instructions to receive a selection of at least one of the compensating WAP configurations identified in the fault tolerance report; and
instructions to configure a WAP manager to apply the at least one selected compensating WAP configuration, in response to receiving the selection.

5. The storage medium of claim 1, wherein, for each coverage monitor, the at least one coverage parameter includes one of a plurality of coverage type parameters, including:
a full-coverage parameter, wherein the full-coverage parameter is satisfied by any coverage prediction having a predicted coverage area including the entire region associated with the coverage monitor; and
a no-coverage parameter, wherein the no-coverage parameter is satisfied by any coverage prediction having a predicted coverage area excluding the entire region associated with the coverage monitor.

6. The storage medium of claim 5, wherein:
the plurality of coverage types further includes a selective coverage parameter satisfied by any coverage prediction;
each trial WAP configuration specifies at least a transmit power value for each of the WAP objects; and
for each of the trial WAP configurations, the disabled WAP object has a transmit power value of zero.

7. The storage medium of claim 5, wherein:
for at least one coverage monitor, the at least one coverage parameter includes at least one of a minimum signal parameter, a maximum signal parameter, and an average signal parameter; and
the instructions to generate the coverage predictions comprise instructions to generate each of the coverage predictions based in part on site characteristics specified by at least one of the site model and the at least one coverage monitor.

8. A computing device comprising:
a memory encoded with a set of executable instructions; and
a processor to execute the instructions, wherein the instructions, when executed, cause the processor to:
receive a plurality of coverage monitors, each specifying at least one coverage parameter for an associated region of a site model including a plurality of wireless access point (WAP) objects;
determine an initial WAP configuration, for the plurality of WAP objects, having a coverage prediction that satisfies each coverage parameter of each coverage monitor;
generate a plurality of trial WAP configurations, each excluding one of the WAP objects;
compare respective coverage predictions for each of the trial WAP configurations to each coverage parameter of each coverage monitor; and
determine, for each WAP object, that the WAP object is a primary WAP object if the respective coverage predictions for each trial WAP configuration excluding the WAP object fails to satisfy at least one coverage parameter of at least one of the coverage monitors; and
generate a fault tolerance report identifying each WAP object determined to be a primary WAP object.

9. The computing device of claim 8, wherein the fault tolerance report further identifies, for each WAP object not determined to be a primary WAP object, a compensating WAP configuration excluding the WAP object, wherein a coverage prediction for the compensating WAP configuration satisfies each coverage parameter for each coverage monitor.

10. The computing device of claim 9, wherein:
the fault tolerance report further identifies, for each WAP object determined to be a primary WAP object, a substitute WAP configuration excluding the WAP object, wherein a coverage prediction for the substitute WAP configuration fails to satisfy at least one coverage parameter of at least one of the coverage monitors; and
the fault tolerance report further identifies, for each substitute WAP configuration, each coverage parameter of the coverage monitors that is not satisfied by the substitute WAP configuration.

11. The computing device of claim 8, wherein the instructions, when executed, further cause the processor to:
generate at least one proposed WAP configuration for the WAP objects, including the initial WAP configuration; and
compare respective coverage predictions for each of the at least one full WAP configurations to each coverage parameter of each coverage monitor.

12. The computing device of claim 8, wherein the instructions to generate the plurality of trial WAP configurations comprise:
instructions to iteratively generate, for each WAP object, trial WAP configurations excluding the WAP object until either a coverage prediction for one of the generated trial WAP configurations excluding the WAP object satisfies each coverage parameter of each coverage monitor or a threshold number of trial WAP configurations excluding the WAP object is generated.

13. A method comprising:
receiving, with a network interface of a computing device, a plurality of coverage monitors, each defining at least one coverage parameter for an associated region of a site model including a plurality of wireless access point (WAP) objects;
storing the coverage monitors in memory of the computing device;
adjusting iteratively WAP settings for a first set of the WAP objects, excluding a first one of the WAP objects, to generate a plurality of first trial WAP configurations, if a coverage prediction for an initial WAP configuration for the WAP objects satisfies each coverage parameter of each coverage monitor;
determining that one of the first trial WAP configurations is a first compensating WAP configuration if a coverage prediction for the one of the first trial WAP configurations satisfies each coverage parameter of each coverage monitor; and
determining that the first WAP object is a primary WAP object if respective coverage predictions for a threshold number of the first trial WAP configurations each fail to satisfy at least one coverage parameter of at least one of the coverage monitors.

14. The method of claim 13, further comprising:
adjusting iteratively WAP settings for a second set of the WAP objects, excluding a second one of the WAP objects, to generate a plurality of second trial WAP configurations;
determining that one of the second trial WAP configurations is a second compensating WAP configuration if a coverage prediction for the one of the second trial WAP configurations satisfies each coverage parameter of each coverage monitor; and
determining that the second WAP object is a primary WAP object if respective coverage predictions for the threshold number of the second trial WAP configurations each fail to satisfy at least one coverage parameter of at least one of the coverage monitors.

15. The method of claim 14, further comprising:
receiving, with the network interface, a respective location for each WAP object within the site model;
determining a substitute WAP configuration excluding the first WAP object if the first WAP object is determined to be a primary WAP object;
monitoring a plurality of WAPs associated with the WAP objects, respectively; and
applying one of the first compensating WAP configuration and the substitute WAP configuration to the WAPs in response to determining that a first WAP, associated with the first WAP object, is malfunctioning.
